(19) United States
(12) Patent Application Publication
(10) Pub. No.: US 2026/0129522 A1
(43) Pub. Date: May 7, 2026

(54) METHOD AND APPARATUS FOR TRANSFER OF UE INFORMATION FOR RRC PROCEDURE IN A WIRELESS COMMUNICATION SYSTEM

(71) Applicant: SAMSUNG ELECTRONICS CO., LTD., Suwon-si, Gyeonggi-do (KR)

(72) Inventors: Jonas SEDIN, Staines, Middlesex (GB); Chadi KHIRALLAH, Staines, Middlesex (GB)

(21) Appl. No.: 19/118,266

(22) PCT Filed: Oct. 16, 2023
(86) PCT No.: PCT/KR2023/015932

§ 371 Date: Apr. 3, 2025

(30) Foreign Application Priority Data
Nov. 2, 2022 (GB) 2216286.1

(51) Int. Cl. H04W 36/00; H04W 36/08; H04W 76/19

(52) U.S. Cl. CPC H04W 36/0033; H04W 36/08; H04W 76/19

(57) ABSTRACT

The disclosure relates to a 5G or 6G communication system for supporting a higher data transmission rate. Specifically, the disclosure related to a first method, for a first base station, for transferring a User Equipment (UE) context from the first base station to a second base station. The first method comprises: in response to obtaining a prediction that a connection of the UE to the first base station will be disconnected, transmitting, to the second base station and before the connection of the UE to the first base station is disconnected, information for performing a Radio Resource Control (RRC) procedure for establishing a connection between the UE and the second base station. There is disclosed a second method, for a second base station, for transferring a User Equipment (UE) context from a first base station to the second base station. The second method comprises: receiving, from the first base station and before a connection of the UE to the first base station is disconnected, information for performing a Radio Resource Control (RRC) procedure for establishing a connection between the UE and the second base station; receiving, from the UE, a message requesting the RRC procedure; and using the received information for performing the RRC procedure.

### TECHNICAL FIELD

The present disclosure relates generally to wireless communication systems and, more specifically, the present disclosure relates to one or more techniques for transferring, between network access points, User Equipment (UE) information for performing a Radio Resource Control (RRC) procedure. For example, certain examples of the present disclosure provide one or more techniques for transferring a UE context from a first base station to a second base station in a 3^{rd} Generation Partnership Project (3GPP) 5^{th} Generation (5G) New Radio (NR) network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure relates to wireless communication systems and, more specifically, the present disclosure relates to method and apparatus for transfer of UE for RRC procedure in a wireless communication system.

### Solution to Problem

In one embodiment, a method, for a first base station, for transferring a User Equipment (UE) context from the first base station to a second base station, the method comprising: in response to obtaining a prediction that a connection of the UE to the first base station will be disconnected, transmitting, to the second base station and before the connection of the UE to the first base station is disconnected, information for performing a Radio Resource Control (RRC) procedure for establishing a connection between the UE and the second base station.

In another embodiment, a method, for a second base station, for transferring a User Equipment (UE) context from a first base station to the second base station, the method comprising: receiving, from the first base station and before a connection of the UE to the first base station is disconnected, information for performing a Radio Resource Control (RRC) procedure for establishing a connection between the UE and the second base station; receiving, from the UE, a message requesting the RRC procedure; and using the received information for performing the RRC procedure.

In another embodiment, a method, for a User Equipment (UE), for connecting to a base station, the method comprising: receiving, from a first base station to which the UE is, or has been, connected, an indication that information for performing a Radio Resource Control (RRC) procedure has been transmitted to (and/or accepted by) one or more second base stations.

### Advantageous Effects of Invention

Aspects of the present disclosure provide efficient communication methods in a wireless communication system.

### BRIEF DESCRIPTION OF DRAWINGS

FIG. 1 illustrates an example of a handover procedure in relation to inter-base station (gNB) transfer;

FIG. 2 illustrates an example of an RRC Re-establishment procedure in relation to inter-gNB signalling;

FIG. 3 illustrates a technique for pre-emptively transferring a UE context from a source gNB to a target gNB in the case of RRC Re-establishment;

FIG. 4 illustrates a technique for pre-emptively transferring a UE context from a source gNB to a target gNB in the case of RRC Resume;

FIG. 5 illustrates a technique for pre-emptively sending a handover request message and configuring the UE to pre-emptively measure certain cells at the start of an RRC Connection procedure;

FIG. 6 illustrates a technique for performing a UE Context Release Request procedure;

FIG. 7 illustrates a technique for estimating the rough location of a UE;

FIG. 8 is a block diagram of an exemplary network entity that may be used in certain examples of the present disclosure;

FIG. 9 illustrates a block diagram of a terminal (or a user equipment (UE), according to embodiments of the present disclosure; and

FIG. 10 illustrates a block diagram of a base station, according to embodiments of the present disclosure.

### MODE FOR THE INVENTION

One of the areas currently under development in 3GPP 5G wireless technology is support for non-terrestrial networks (NTNs). An NTN is a network in which one or more nodes (e.g. a Next Generation Radio Access Network (NG-RAN) node) are provided by a non-terrestrial infrastructure, for example a satellite or High Altitude Platform Station (HAPS). Advantages of using an NTN include (i) extending coverage to regions, such as remote areas, with limited or no coverage from more traditional terrestrial networks, (ii) providing continuous coverage in the event of inoperability of traditional terrestrial networks, such as during natural disasters, and (iii) enhancing overall reliability, resilience and capacity when used in conjunction with existing terrestrial networks.

A satellite network implementing a network node provides coverage through one or more radio beams forming a “footprint” on the surface of the Earth defining a coverage area or cell. An NTN cell may be Earth-moving (i.e. moving over the Earth's surface according to the motion of the satellite, for example in the case of a Lower Earth Orbit (LEO) satellite), Earth-fixed (i.e. a fixed area of the Earth's surface, for example in the case of a Geosynchronous Equatorial Orbit (GEO) satellite) or quasi-Earth-fixed (i.e. a fixed area of the Earth's surface but is maintained for only a limited time as the satellite passes by).

Internet of Things (IoT) NTN was a 3GPP study and work item in 3GPP Release 17 (RP-202689) to provide NTN access for Evolved Universal Terrestrial Radio Access Network (E-UTRAN) IoT devices (e.g. Narrowband (NB)-IoT and Long Term Evolution Machine Type Communication (LTE-M), including enhanced Machine Type Communication (eMTC)). As noted in 3GPP RP-202689, IoT operation is critical in remote areas with low/no cellular connectivity for many different industries. The capabilities of NB-IoT and eMTC are a good fit for many applications but some applications may require satellite connectivity to provide coverage beyond terrestrial deployments.

Due to the movement of satellites in a non-stationary orbit (e.g. LEO), the cells that a UE see will be moving (i.e. Earth-moving cells). This results in frequent UE handover from one cell to another, and this handover of service will happen constantly. In view of this, mobility is one of the key issues in both NR NTN and IoT NTN.

During the study item on IoT NTN Release 17, different methods of supporting enhanced mobility with the special circumstances of NTN were discussed. In particular the problem of mobility for NB-IoT.

In NB-IoT, to support a more simplified implementation compared to Long Term Evolution (LTE), mobility functions are not specified or severely simplified. As an example, for NB-IoT Release 13 (the first release of NB-IoT), there is no RRC connected mode mobility, meaning that there are no handover commands defined and no connected mode neighbour cell measurements defined. Instead, mobility in RRC connected mode is done through the connection to the serving cell deteriorating forcing the UE to perform Radio Link Failure (RLF) and then re-establishing to a more suitable cell through the RRC re-establishment procedure.

The above information is presented as background information only to assist with an understanding of the present disclosure. No determination has been made, and no assertion is made, as to whether any of the above might be applicable as prior art with regard to the present invention.

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present invention is defined in the independent claims. Advantageous features are defined in the dependent claims.

Embodiments or examples disclosed in the description and/or figures falling outside the scope of the claims are to be understood as examples useful for understanding the present invention.

Other aspects, advantages and salient features of the invention will become apparent to those skilled in the art from the following detailed description taken in conjunction with the accompanying drawings.

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made without departing from the scope of the invention.

The same or similar components may be designated by the same or similar reference numerals, although they may be illustrated in different drawings.

Detailed descriptions of techniques, structures, functions, operations or processes known in the art may be omitted for clarity and conciseness, and to avoid obscuring the subject matter of the present invention.

The terms and words used herein are not limited to the bibliographical or standard meanings, but, are merely used to enable a clear and consistent understanding of the invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

The skilled person will appreciate that the techniques described herein may be used in any suitable combination.

Certain examples of the present disclosure provide one or more methods, apparatus and/or systems for transferring, between network access points, UE information for performing an RRC procedure. For example, certain examples of the present disclosure provide one or more methods, apparatus and/or systems for transferring a UE context from a first base station to a second base station in a 3GPP 5G NR network. However, the skilled person will appreciate that the present invention is not limited to these examples, and may be applied in any suitable system or standard, for example one or more existing and/or future generation wireless communication systems or standards, including any existing or future releases of the same standards specification, for example 3GPP 5G.

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network. For example, the functionality of a NG-RAN node (e.g. a base station or gNB) in the examples below may be applied to any other suitable type of entity performing RAN functions.

A particular network entity may be implemented as a network element on a dedicated hardware, as a software instance running on a dedicated hardware, and/or as a virtualised function instantiated on an appropriate platform, e.g. on a cloud infrastructure.

The skilled person will appreciate that the present invention is not limited to the specific examples disclosed herein. For example:
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements or entities may be added to the examples disclosed herein.
One or more non-essential elements or entities may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed and/or the order in which messages are transmitted may be modified, if possible, in alternative examples.

Certain examples of the present disclosure may be provided in the form of an apparatus/device/network entity configured to perform one or more defined network functions and/or a method therefor. Certain examples of the present disclosure may be provided in the form of a system (e.g. network or wireless communication system) comprising one or more such apparatuses/devices/network entities, and/or a method therefor.

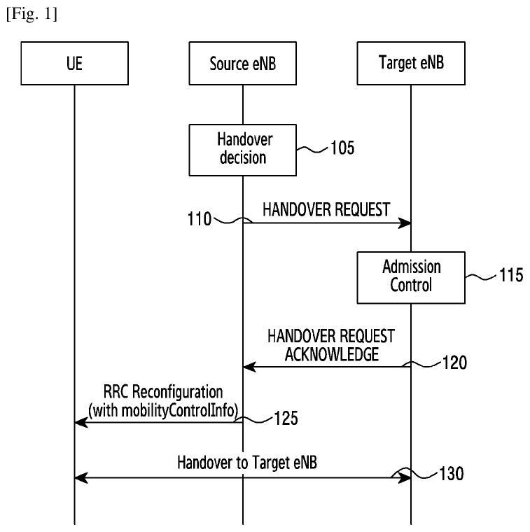

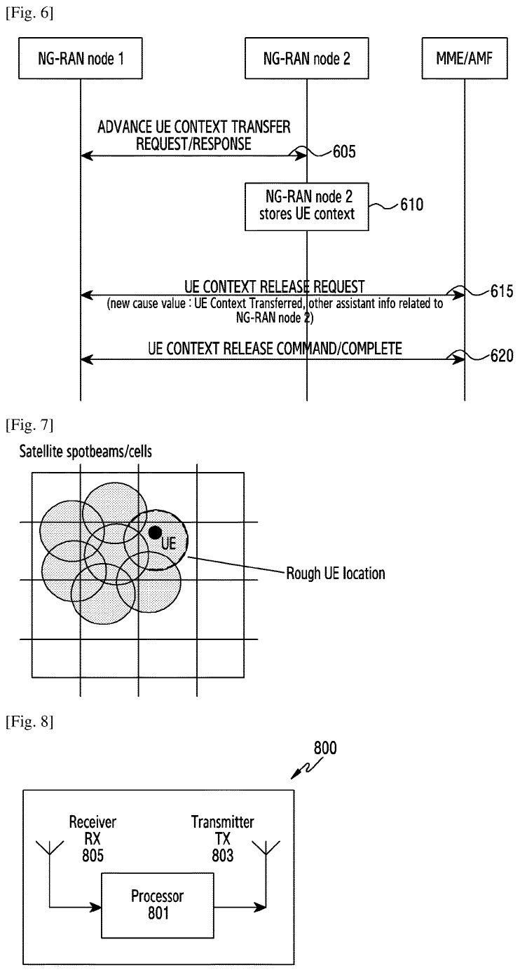

FIG. 1 through FIG. 10, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any suitably arranged system or device.

FIG. 1 illustrates an example of a handover procedure in relation to inter-base station (e.g. eNB or gNB) transfer. For example, FIG. 1 describes an LTE handover procedure across the RAN-side according to 3GPP TS 36.300 V17.2.0.

Although the examples below refer to eNB or gNB, the skilled person will appreciate that any suitable type of RAN node or network access point may be used in the various examples disclosed herein.

Referring to FIG. 1, in Step 105, a source eNB decides that a UE should be handed over to a target eNB. This determination may be based on any suitable criteria according to implementation, for example measurements from the UE, or load-controlled.

In Step 110, the source eNB sends a handover request message to the target eNB to inform the target eNB of handover of the UE from the Source eNB to the Target eNB. The handover request message may comprise any suitable information, for example a UE context. The UE context may comprise any suitable information, for example one or more of the following:
UE Security Capabilities Information Element (IE),
Access Stratum (AS) Security Information IE,
Subscriber Profile Identity (ID) for Radio Access Technology (RAT)/Frequency priority IE,
Additional Radio Resource Management (RRM) Policy Index IE,
Handover Restriction List IE,
Location Reporting Information IE,
Management Based Minimisation of Drive Test (MDT) Allowed IE,
Management Based MDT Public Land Mobile Network (PLMN) List IE,
Trace Activation IE,
Single Radio Voice Call Continuity (SRVCC) Operation Possible IE,
Masked International Mobile station Equipment Identity and Software Version (IMEISV) IE
Expected UE Behaviour IE,
Proximity-based Services (ProSe) Authorized IE,
Vehicle to Everything (V2X) Services Authorized IE,
Aerial UE subscription information IE,
Subscription Based UE Differentiation Information IE,
Evolved Packet Core (EPC) Handover Restriction List Container IE,
Security Indication IE,

In Step 115, the target eNB performs admission control according to implementation to determine whether to accommodate the UE. For example, the Target eNB may determine whether handover to the Target eNB is allowed and/or possible.

In Step 120, the Target eNB sends a handover request acknowledgement message to the Source eNB, which signals to the Source eNB that the Source eNB may hand over the service to the Target eNB. The handover request acknowledgement message may comprise any suitable information, for example Configuration for the UE communicating with the Target eNB and/or Contention Free Random Access (CFRA) resources for handover to the Target eNB.

In Step 125, the Source eNB sends an RRC Reconfiguration message to the UE. The RRC Reconfiguration message may comprise any suitable information, for example mobility control information.

In Step 130, handover of the UE from the Source eNB to the Target eNB is performed.

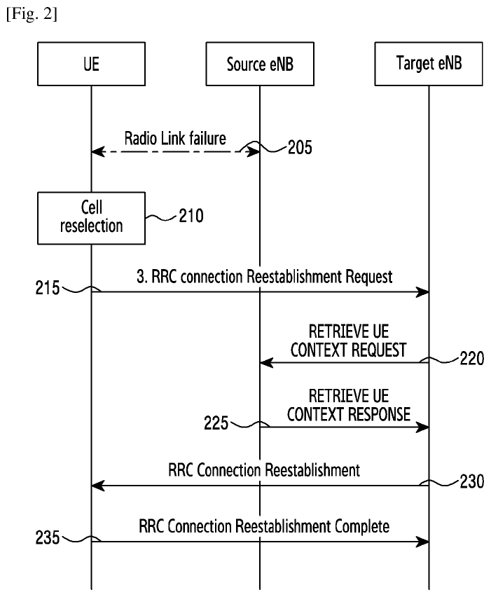

FIG. 2 illustrates an example of an RRC Re-establishment procedure in relation to inter-gNB signalling, for example according to 3GPP TS 36.300 V17.2.0.

Referring to FIG. 2, in Step 205, when Radio Link Failure (RLF) occurs on a connection between a UE and a Source eNB, RLF is triggered at the UE.

In Step 210, the UE triggers a re-establishment procedure. The re-establishment procedure may include cell selection where a suitable cell is selected.

In Step 215, the UE sends an RRC Connection Reestablishment Request message to the selected cell (Target eNB). The RRC Connection Reestablishment Request message may comprise any suitable information, for example a UE identity (e.g., cell Radio Network Temporary Identifier (c-RNTI), physCellId and shortMAC-I) and/or a reestablishment cause.

In Step 220, the Target eNB identifies the UE based on the UE identity in the RRC Connection Reestablishment Request message and determines that the Target eNB has no UE context for the identified UE. Accordingly, the Target eNB transmits a Retrieve UE Context Request message to the Source eNB to request the UE context of the identified UE from the Source eNB.

In Step 225, the Source eNB responds to the Retrieve UE Context Request message of Step 220 by transmitting a Retrieve UE Context Response message to the Target eNB. The Retrieve UE Context Response message may include the UE context of the identified UE.

In Step 230, the Target eNB transmits an RRC Connection Reestablishment message to the UE in response to the RRC Connection Reestablishment Request message of Step 215. The RRC Connection Reestablishment message may comprise any suitable information, for example an RRC configuration for the UE.

In Step 235, the UE transmits an RRC Connection Reestablishment Complete message to the Target eNB in response to the RRC Connection Reestablishment message of Step 230. At this time, a connection is established between the UE and the Target eNB and the UE may perform data communication.

In the procedure of FIG. 2, the Target eNB may send an RLF indication to the Source eNB to signal that UE re-establishment to the Target eNB has occurred due to RLF. The RLF indication may comprise any suitable information, for example one or more of the following:
Failure cell Physical Cell ID (PCI)—this indicates the cell where the RLF occurred.
UE RLF Report Container—this indicates how the RLF occurred.
RRC Connection Setup Indicator—this information may be included if the UE has performed RRC Connection Setup to the UE and then retrieved an RLF report.
RRC Connection Re-establishment indicator—this indicates the type or cause of the RLF, for example whether the RRC connection re-establishment is due to reconfiguration failure, handover failure or other failure.
NB-IoT RLF Report Container—this includes an NB-IoT specific RLF report.

At least the following problem exist in view of the related art:

In Release 17 IoT NTN, it is an aim to provide techniques for performing the RRC re-establishment procedure more quickly and more reliably following RLF. Part of the re-establishment procedure involves the target eNB acquiring the UE context. However, acquiring the UE context may introduce delays in the procedure. This may be a problem particularly in the case of NTN applications in which there may be constant mobility requiring frequent re-establishment.

In the present disclosure, the terms source eNB, old NB and eNB1 may refer to an eNB that the UE is currently or previously connected to, and may be used inter-changeably. Similarly, in the present disclosure, the terms target eNB, new eNB and eNB2 may refer to an eNB that the UE will connect to in the future, may potentially be connected to in the future or has just recently connected to, and may be used inter-changeably.

In certain examples of the present disclosure, a source eNB may pre-emptively send information (for example a UE context) for performing an RRC procedure (for example RRC Re-establishment and/or RRC Resume) to a target eNB in advance of an event (for example RLF and/or handover) that may require the RRC procedure to be performed. To achieve this, one or more network entities (e.g., source eNB, target eNB and/or UE) may predict the occurrence of the event based on any suitable information. For example, based on known movements (e.g., trajectories/orbits) of one or more satellites in NTN, it may be feasible to predict when a future handover (e.g., inter-/intra-satellite handover) might occur. Accordingly, when the event occurs, the RRC procedure can be performed more quickly since the target eNB already has the required information. For example, a UE may more quickly establish an RRC connection with the target eNB (for example according to an RRC Re-establish or RRC Resume procedure) since the target eNB already has the UE context. The information for performing the RRC procedure may be sent using any suitable message, including any suitable existing type of message or a newly defined message.

The X2/Xn interface (interface between RAN nodes) may get overloaded if there are many UEs attempting RRC connection with the same target eNB at the same time. In certain examples of the present disclosure, since information (e.g., UE context) for performing an RRC procedure is pre-emptively transmitted between RAN nodes in advance, the load on the X2/Xn interface can be managed more effectively to reduce the risk of overload.

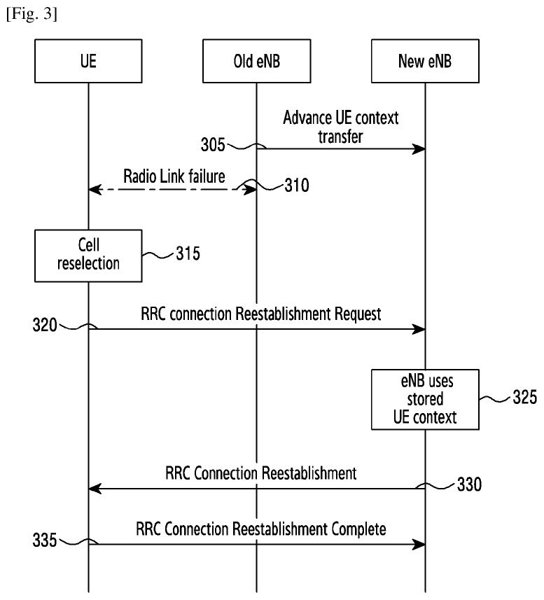

FIG. 3 illustrates a technique for pre-emptively transferring a UE context from a source eNB to a target eNB in the case of RRC Re-establishment. As shown in FIG. 3, in Step 305 information (UE context) for performing an RRC procedure (RRC Re-establishment or RRC Resume) is transmitted from a source eNB (or old eNB) to a target eNB (or new eNB) before an event occurs in Step 310 (RLF or RRC Connection Release) which requires the RRC procedure to be subsequently performed in Steps 315, 320, 330 and 335. In particular, at Step 325 the information (UE context) for performing the RRC procedure is already available at the target eNB.

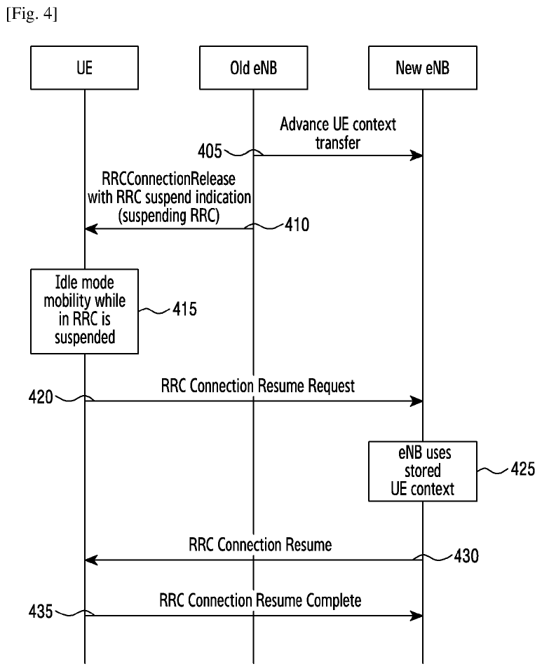

FIG. 4 illustrates a technique for pre-emptively transferring a UE context from a source eNB to a target eNB in the case of RRC Resume. As shown in FIG. 4, in Step 405 information (UE context) for performing an RRC procedure (RRC Re-establishment or RRC Resume) is transmitted from a source eNB (or old eNB) to a target eNB (or new eNB) before an event occurs in Step 410 (RLF or RRC Connection Release) which requires the RRC procedure to be subsequently performed in Steps 415, 420, 430 and 435. In particular, at Step 425 the information (UE context) for performing the RRC procedure is already available at the target eNB.

In certain examples, the source eNB may perform the following. First, the source eNB may determine that the UE might need to perform mobility/handover, for example through RLF and RRC re-establishment procedure or through RRC Resume procedure. In response to the determination, the source eNB may send information needed for RRC re-establishment or RRC Resume for a UE to the target eNB.

In certain examples, the source eNB may send the information (e.g., UE context) needed for RRC re-establishment in a HANDOVER REQUEST message or any other suitable message. A HANDOVER REQUEST message is typically followed by a HANDOVER REQUEST ACKNOWLEDGEMENT message. In certain examples, the HANDOVER REQUEST ACKNOWLEDGEMENT message may include one or more indicators (e.g., one or more flags), for example indicating that the UE context is for a RRC re-establishment request and/or for indicating that a response (for example a HANDOVER REQUEST RESPONSE) including UE configuration is not needed. In certain examples, a response with HANDOVER REQUEST ACKNOWLEDGEMENT may not be needed at all.

In certain examples, the source eNB may send the information (e.g., UE context) needed for RRC re-establishment or RRC Resume in a RETRIEVE UE CONTEXT RESPONSE message. The RETRIEVE UE CONTEXT RESPONSE message may comprise information indicating that the message content is applicable for RRC Re-establishment.

In certain examples, the source eNB may transmit to the target eNB information (e.g., a set of UE contexts) relating to two or more, or all, UEs connected to the source eNB.

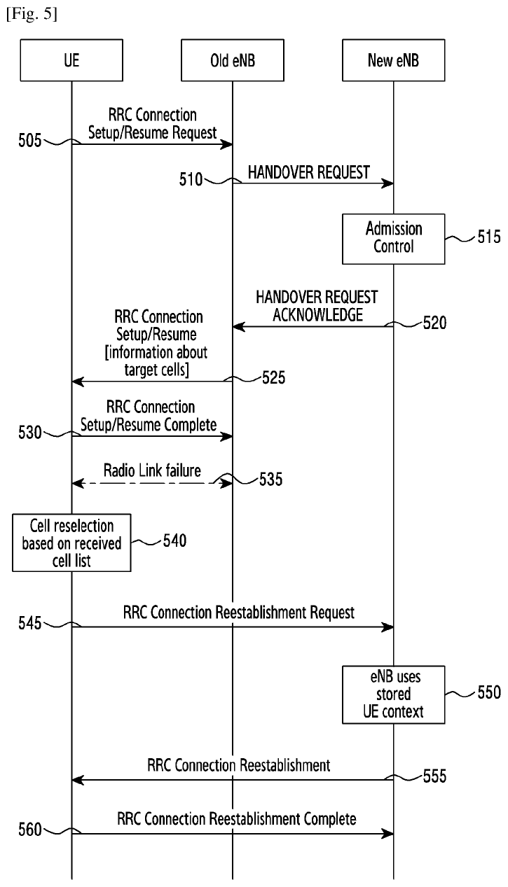

In certain examples, the network may send a HANDOVER REQUEST message whenever a UE establishes an RRC connection and may wait for a HANDOVER REQUEST ACKNOWLEDGEMENT message before establishing an RRC connection with a UE. Then, the UE may be configured to measure certain target eNBs (for example defined by a received list of eNBs) while in connected mode. This allows RRC re-establishment to be performed faster since it is not required to perform lengthy measurements while in RRC idle mode upon Radio Link Failure. In certain examples, an indication may be included in the HANDOVER REQUEST message to notify that the re-establishment might not occur for a long time. This technique may be useful in the case of NB-IoT as an NB-IoT UE may not be re-configured. An example of this technique is illustrated in FIG. 5.

Referring to FIG. 5, in Step 525 the source eNB transmits, to the UE, a list of cells corresponding to eNBs that have responded to the advance HANDOVER REQUEST message in Step 510. In Step 540 the UE performs cell reselection to one of the cells in the cell list configured in Step 525.

In certain examples, the UE may receive information indicating which eNBs have received the UE context in advance (e.g., pre-emptively). The UE may then select certain cells based on this information. For example, the UE may select cells corresponding to eNBs that have received the UE context in advance since it may be faster to re-establish a connection to these cells. In certain examples, in the cell selection procedure, the UE may prioritize cells corresponding to eNBs where the UE context has been pre-emptively sent. In certain examples, some or all of the eNBs that have received the UE context in advance may not actually be available, for example due to an error in the prediction. In this case, a cell corresponding to an eNB where the UE context has not been pre-emptively sent may be selected.

In certain examples, if the source eNB provides the target eNB with a UE context, the target eNB may ignore the UE context based on admission control (e.g., see Step 115 of FIG. 1 and Step 515 of FIG. 5). For example, if the target eNB is not allowed, or is unable to admit the handover request, for example due to congestion at the target eNB, then the target eNB may discard or ignore the received UE context. In certain examples, the target eNB may explicitly indicate to the source eNB its rejection to accept the UE context (or that the UE context is being ignored) at this given time (and/or location). In certain examples, the indication may include any suitable existing or newly defined rejection cause (e.g., “UE Context Not supported”, “No UE Admission”, etc.). The indication may be provided to the source eNB using any suitable existing or newly defined message, including any suitable message disclosed herein.

In certain examples, the target eNB may perform the following. First, the target eNB may receive (and store) information needed for RRC re-establishment or RRC Resume. Next, the target eNB may receive an RRC re-establishment request or RRC Resume request from the UE. Then, the target eNB may use the previously received and stored information to re-establish or resume the UE in the target eNB.

In certain examples, the target eNB may be configured to store a UE context for only a certain time period after it has been received from the source eNB, for example using a timer.

In certain examples, if the re-establishment has been configured using the UE context provided in advance, the target eNB may not send a RLF indication.

In certain examples, an RLF indication may be sent by the target eNB with an indication that the UE context was available when re-establishing the eNB.

In certain examples, the target eNB may send a Handover Report to the source eNB if a re-establishment or RRC Resume with prepared UE context is received.

In certain examples, an eNB may request to pre-emptively receive any UE contexts, or any further UE contexts, in advance. That is, the eNB may request to apply the techniques described herein. This may be done, for example, by sending a flag in a RETRIEVE UE CONTEXT REQUEST message, or by including a specific pre-configured UE ID that signals that the eNB requests potential future UE contexts.

The skilled person will appreciate that the techniques described herein are applicable to various types of network entity, including eNB, gNB and/or NG-RAN node and related RRC signalling and/or messages.

The skilled person will also appreciate that certain examples of the present disclosure may include one or more additional network entities not shown in the figures, for example Serving Gateway (S-GW), Mobility Management Entity (MME), Session Management Function (SMF), User Plane Function (UPF), Access and Mobility Management Function (AMF) and/or any other suitable type of network entity.

In certain examples, the source eNB may trigger UE context release at the source eNB, for example, by sending RRC Release request to the MME (or AMF) in order for the later to initiate the UE context release procedure. In certain examples, the source eNB may include an existing or a newly defined cause value indicating the reason for the UE context release (e.g., UE Context Transferred, Advance UE Context Transfer, or any other suitable naming).

### X2 Examples (3GPP TS 36.423)

To signal the advance UE context in the HANDOVER REQUEST, this can be done through the following example by including a flag either for re-establishment or for RRC resume:

### 9.1.1.1. Handover Request

This message is sent by the source eNB to the target eNB to request the preparation of resources for a handover.
Direction: source eNB→target eNB.

In one example:

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.2.13 | | YES | reject |
| Old eNB UE X2AP ID | M | eNB UE X2AP ID | Allocated at | YES | reject |
| | | 9.2.24 | the source | | |
| | | | eNB | | |
| Cause | M | 9.2.6 | | YES | ignore |
| Target Cell ID | M | ECGI | | YES | reject |
| | | 9.2.14 | | | |
| GUMMEI | M | 9.2.16 | | YES | reject |

. . .

| | | | | |
|---|---|---|---|---|
| Re-establishment | O | ENUMERATED | YES | ignore |
| advance UE context | | (true, . . . ) | | |
| Resume advance UE | O | ENUMERATED | YES | ignore |
| context | | (true, . . . ) | | |

In another example:

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.2.13 | | YES | reject |
| Old eNB UE X2AP ID | M | eNB UE X2AP ID | Allocated at | YES | reject |
| | | 9.2.24 | the source | | |
| | | | eNB | | |
| Cause | M | 9.2.6 | | YES | ignore |
| Target Cell ID | M | ECGI | | YES | reject |
| | | 9.2.14 | | | |
| GUMMEI | M | 9.2.16 | | YES | reject |

. . .

| | | | | |
|---|---|---|---|---|
| Advance UE Context | O | ENUMERATED | YES | ignore |
| Transfer | | (true, . . . ) | | |

Note that similar changes/updates can also be applied to corresponding Xn procedures.

### Handover Request (3GPP TS 38.423)

This message is sent by the source NG-RAN node to the target NG-RAN node to request the preparation of resources for a handover.
Direction: source NG-RAN node→target NG-RAN node.

In one example:

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| Source NG-RAN node | M | | NG-RAN node UE | Allocated at | YES | reject |
| UE XnAP ID reference | | | XnAP ID | the source | | |
| | | | 9.2.3.16 | NG-RAN | | |
| | | | | node | | |
| Cause | M | | 9.2.3.2 | | YES | reject |
| Target Cell Global ID | M | | 9.2.3.25 | Includes either | YES | reject |
| | | | | an E-UTRA | | |
| | | | | CGI or an NR | | |
| | | | | CGI | | |
| GUAMI | M | | 9.2.3.24 | | YES | reject |
| UE Context | | 1 | | | YES | reject |
| Information | | | | | | |
| . . . | O | | | | | |
| 5G ProSe PC5 QoS | O | | 9.2.3.160 | This IE | YES | ignore |
| Parameters | | | | applies only if | | |
| | | | | the UE is | | |
| | | | | authorized for | | |
| | | | | 5G ProSe | | |
| | | | | services. | | |
| Advance UE Context | O | | ENUMERATED | | YES | ignore |
| Transfer | | | (true, . . . ) | | | |

In the following, exemplary techniques for predicting that a connection will be disconnected are described.

In certain examples, a prediction that a UE will (or is likely to) be disconnected may be obtained based on any suitable information, for example one or more of the following:

1. The location of the UE (e.g., the UE location known to within a certain threshold accuracy). In certain examples, only a rough UE location may be known (e.g., a location with a relatively low accuracy).

2. The location of the eNB to which the UE is currently connected. In certain examples, the eNB location may be determined based on ephemeris data of the satellite corresponding to the eNB.

3. The locations of the neighbouring eNBs. In certain examples, the neighbouring eNB locations may be determined based on ephemeris data of the satellites corresponding to the neighbouring eNBs.

4. Quasi-Earth-fixed specific information.

In certain examples, a rough UE location may be estimated based on which cell the UE is connected to, and at which time. An example of this is illustrated in FIG. 7.

In certain examples, the eNB is aware of its own location and may broadcast corresponding satellite ephemeris data in System Information. This data/information may be supplied by a central entity, for example a satellite command control, orbital command control, or similar. A central entity may have detailed knowledge of satellite locations and/or satellite orbital trajectories, and may supply an eNB with the satellite ephemeris of neighbouring eNBs.

In certain examples, the way the above information is used may be based on whether the satellite operates according to an earth-moving or earth-fixed scenario.

In certain examples, for an earth-moving scenario, the appropriate information (e.g., satellite location and/or orbital trajectory) relating to an eNB may be used to estimate the path loss to a UE and what time the path loss will degrade to a certain point where it is likely that a disconnection might occur. Similarly, the appropriate information (e.g., satellite location and/or orbital trajectory) relating to neighbouring eNBs may be used to determine which eNB(s) the UE is likely to be connected to in the future.

In certain examples, for a quasi-earth-fixed scenario, an eNB will typically stop serving an area at a fixed point, where the UE will thus be disconnected. Accordingly, from this information it is possible to determine (e.g., by an eNB) at what point, and by which eNB, the UE is likely to be served in the future.

Although certain examples of the present disclosure have been described with reference to NTN, the skilled person will appreciate that the present disclosure is not limited to NTN. For example, the techniques described herein may be applied to any suitable type of network, including a terrestrial network or a network comprising a mixture of a terrestrial network and an NTN.

Although certain examples of the present disclosure have been described with reference to NB-IoT UEs, the skilled person will appreciate that the present disclosure is not limited to NB-IoT UEs. For example, the techniques described herein may be applied to any suitable type of device including other types of UEs and/or other types of IoT devices.

Although certain examples of the present disclosure have been described with reference to predicting when a UE will connect to an eNB based on information relating to the location and/or orbital trajectories of one or more satellites, the skilled person will appreciate that the present disclosure is not limited to this case. For example, the techniques described herein may be applied to any situation in which the connection of a UE to an eNB may be predicted based on any suitable information, for example predicted motion of the UE (e.g. causing a UE to move between cells) and/or prediction based on network analytics relating to eNB load (e.g. requiring handover from an overloaded cell to a cell with lower load).

FIG. 8 is a block diagram of an exemplary network entity that may be used in examples of the present disclosure. For example, a UE and/or gNB in the examples of FIGS. 1-7 may comprise an entity of FIG. 8. The skilled person will appreciate that a network entity may be implemented, for example, as a network element on a dedicated hardware, as a software instance running on a dedicated hardware, and/or as a virtualised function instantiated on an appropriate platform, e.g., on a cloud infrastructure.

The entity 800 comprises a processor (or controller) 801, a transmitter 803 and a receiver 805. The receiver 805 is configured for receiving one or more messages from one or more other network entities, for example as described above. The transmitter 803 is configured for transmitting one or more messages to one or more other network entities, for example as described above. The processor 801 is configured for performing one or more operations, for example according to the operations as described above.

The techniques described herein may be implemented using any suitably configured apparatus and/or system. Such an apparatus and/or system may be configured to perform a method according to any aspect, embodiment, example, or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

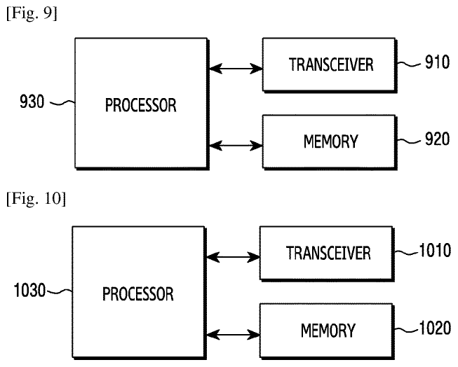

FIG. 9 illustrates a block diagram of a terminal (or a user equipment (UE)), according to embodiments of the present disclosure. FIG. 9 corresponds to the example of the UE of FIG. 1.

As shown in FIG. 9, the UE according to an embodiment may include a transceiver 910, a memory 920, and a processor 930. The transceiver 910, the memory 920, and the processor 930 of the UE may operate according to a communication method of the UE described above. However, the components of the UE are not limited thereto. For example, the UE may include more or fewer components than those described above. In addition, the processor 930, the transceiver 910, and the memory 920 may be implemented as a single chip. Also, the processor 930 may include at least one processor.

The transceiver 910 collectively refers to a UE receiver and a UE transmitter, and may transmit/receive a signal to/from a base station or a network entity. The signal transmitted or received to or from the base station or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the UE. Also, the memory 920 may store control information or data included in a signal obtained by the UE. The memory 920 may be a storage medium, such as read-only memory (ROM), random access memory (RAM), a hard disk, a CD-ROM, and a DVD, or a combination of storage media.

The processor 930 may control a series of processes such that the UE operates as described above. For example, the transceiver 910 may receive a data signal including a control signal transmitted by the base station or the network entity, and the processor 930 may determine a result of receiving the control signal and the data signal transmitted by the base station or the network entity.

FIG. 10 illustrates a block diagram of a base station, according to embodiments of the present disclosure. FIG. 10 corresponds to the example of the eNB of FIG. 1.

As shown in FIG. 10, the base station according to an embodiment may include a transceiver 1010, a memory 1020, and a processor 1030. The transceiver 1010, the memory 1020, and the processor 1030 of the base station may operate according to a communication method of the base station described above. However, the components of the base station are not limited thereto. For example, the base station may include more or fewer components than those described above. In addition, the processor 1030, the transceiver 1010, and the memory 1020 may be implemented as a single chip. Also, the processor 1030 may include at least one processor.

The transceiver 1010 collectively refers to a base station receiver and a base station transmitter, and may transmit/receive a signal to/from a terminal or a network entity. The signal transmitted or received to or from the terminal or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1020 may store a program and data required for operations of the base station. Also, the memory 1020 may store control information or data included in a signal obtained by the base station. The memory 1020 may be a storage medium, such as read-only memory (ROM), random access memory (RAM), a hard disk, a CD-ROM, and a DVD, or a combination of storage media.

The processor 1030 may control a series of processes such that the base station operates as described above. For example, the transceiver 1010 may receive a data signal including a control signal transmitted by the terminal, and the processor 1030 may determine a result of receiving the control signal and the data signal transmitted by the terminal.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

Certain examples of the present disclosure provide a method, for a first base station, for transferring a User Equipment (UE) context from the first base station to a second base station, the method comprising: in response to obtaining a prediction that a connection of the UE to the first base station will be disconnected, transmitting, to the second base station and before the connection of the UE to the first base station is disconnected, information for performing a Radio Resource Control (RRC) procedure for establishing a connection between the UE and the second base station.

In certain examples, obtaining the prediction that the connection of the UE to the first base station will be disconnected may comprise obtaining a prediction that one or more of (i) Radio Link Failure (RLF), (ii) handover, and (iii) suspension of RRC connection will occur.

In certain examples, the RRC procedure may comprise one or more of (i) RRC Reestablishment, and (ii) RRC Resume.

In certain examples, obtaining the prediction may comprise (i) determining, by the first base station, the prediction, or (ii) receiving the prediction from the UE or another network entity.

In certain examples, obtaining the prediction may comprise predicting that the connection of the UE to the first base station will be disconnected based on information on the relative movement between the UE and a cell or coverage area of the first base station.

In certain examples, the first base station may be a Non-Terrestrial Network (NTN) base station, and the information on the relative movement may comprise information on movement of the cell or coverage area based on movement of the NTN base station.

In certain examples, the information on the relative movement may comprise information on movement of the UE.

In certain examples, the information for performing the RRC procedure may comprise a UE context for the UE.

In certain examples, the information for performing a Radio Resource Control (RRC) procedure may be transmitted in one or more of (i) a HANDOVER REQUEST message, and (ii) RETRIEVE UE CONTEXT RESPONSE message.

In certain examples, the method may further comprise transmitting, to the UE, an indication that the information for performing the Radio Resource Control (RRC) procedure has been transmitted to the second base station.

In certain examples, the method may further comprise: transmitting, to each of one or more base stations including the second base station, a handover request message; receiving one or more handover request acknowledgement messages in response to the handover request messages; and transmitting, to the UE and before the connection of the UE to the first base station is disconnected, information indicating which of the base stations transmitted a handover request acknowledgement message, whereby the UE may perform a cell measurement for certain base stations based on the transmitted information.

Certain examples of the present disclosure provide a method, for a second base station, for transferring a User Equipment (UE) context from a first base station to the second base station, the method comprising: receiving, from the first base station and before a connection of the UE to the first base station is disconnected, information for performing a Radio Resource Control (RRC) procedure for establishing a connection between the UE and the second base station; receiving, from the UE, a message requesting the RRC procedure; and using the received information for performing the RRC procedure.

In certain examples, the method may further comprise deleting, by the second base station, the received information a certain time period after receiving the information.

In certain examples, the message requesting the RRC procedure may be one or more of (i) an RRC Re-establishment request message, and (ii) a RRC Resume request message.

In certain examples, the method may further comprise transmitting a message indicating that the information for performing the RRC procedure has been received by the second base station.

In certain examples, the method may further comprise transmitting a message requesting to receive information for performing the RRC procedure.

In certain examples, the information for performing the RRC procedure may comprise a UE context for the UE.

In certain examples, the method may further comprise: in response to receiving the information for performing the RRC procedure, determining whether to accept the information.

In certain examples, the method may further comprise transmitting a message indicating whether the information for performing the RRC procedure is accepted.

In certain examples, the method may further comprise transmitting a message indicating whether the information for performing the RRC procedure is rejected.

Certain examples of the present disclosure provide a method, for a User Equipment (UE), for connecting to a base station, the method comprising: receiving, from a first base station to which the UE is, or has been, connected, an indication that information for performing a Radio Resource Control (RRC) procedure has been transmitted to (and/or accepted by) one or more second base stations.

In certain examples, the method may further comprise: disconnecting from the first base station; selecting another base station based on the received indication; and connecting to the selected other base station.

In certain examples, the other base station may be selected from among the second base stations.

In certain examples, the other base station may be not selected from among the second base stations if none of the second base stations are available.

In certain examples, the other base station may be selecting according to a scheme that prioritises the second base stations.

In certain examples, the method may further comprise, based on the received indication, performing a cell measurement for each of one or more cells corresponding to one or more of the second base stations.

In certain examples, the cell measurements may be performed before the UE disconnects from the first base station.

Certain examples of the present disclosure provide a first base station configured to perform a method according to any aspect, example, embodiment or claim disclosed herein.

Certain examples of the present disclosure provide a second base station configured to perform a method according to any aspect, example, embodiment or claim disclosed herein.

Certain examples of the present disclosure provide a UE configured to perform a method according to any aspect, example, embodiment or claim disclosed herein.

Certain examples of the present disclosure provide a network (or wireless communication system) comprising a first base station, a second base station and a UE according to any aspects, examples, embodiments or claims disclosed herein.

Certain examples of the present disclosure provide a computer program comprising instructions which, when the program is executed by a computer or processor, cause the computer or processor to carry out a method according to any aspect, example, embodiment or claim disclosed herein.

Certain examples of the present disclosure provide a computer or processor-readable data carrier having stored thereon a computer program according to any aspect, example, embodiment or claim disclosed herein.

While the invention has been shown and described with reference to certain examples, it will be understood by those skilled in the art that various changes in form and detail may be made therein without departing from the scope of the invention, as defined by the appended claims.

### ABBREVIATIONS/DEFINITIONS

In the present disclosure, the following acronyms/definitions are used.
3GPP 3^{rd} Generation Partnership Project
5G 5^{th} Generation
AMF Access and Mobility management Function
AS Access Stratum
CFRA Contention Free Random Access
eMTC enhanced Machine Type Communication
eNB Base Station
EPC Evolved Packet Core
E-UTRAN Evolved Universal Terrestrial Radio Access Network
GEO Geosynchronous Equatorial Orbit
gNB 5G Base Station
HAPS High Altitude Platform Station
ID Identity/Identification
IE Information Element
IMEISV International Mobile station Equipment Identity and Software Version
IoT Internet of Things
LEO Lower Earth Orbit
LTE Long Term Evolution
LTE-M LTE Machine Type Communication
MAC Medium Access Control
MDT Minimisation of Drive Test
MME Mobility Management Entity
NB Narrow Band
NG Next Generation
NR New Radio
NTN Non-Terrestrial Network
PCI Physical Cell ID
PLMN Public Land Mobile Network
ProSe Proximity-based Services
RAN Radio Access Network
RAT Radio Access Technology
RLF Radio Link Failure
c-RNTI Cell Radio Network Temporary Identifier
RRC Radio Resource Control
RRM Radio Resource Management
S-GW Serving Gateway
SMF Session Management Function
SRVCC Single Radio Voice Call Continuity
TS Technical Specification
UE User Equipment
UPF User Plane Function
V2X Vehicle to Everything
X2/Xn Interface between RAN nodes

1. A method performed by a first base station, for transferring a user equipment (UE) context from the first base station to a second base station in a wireless communication system, the method comprising:
in response to obtaining a prediction that a connection of the UE to the first base station will be disconnected, transmitting, to the second base station and before the connection of the UE to the first base station is disconnected, information for performing a Radio Resource Control (RRC) procedure for establishing a connection between the UE and the second base station.

2. A method of claim 1, wherein obtaining the prediction that the connection of the UE to the first base station will be disconnected comprises obtaining a prediction that at least one of Radio Link Failure (RLF), handover, or suspension of RRC connection will occur.

3. A method of claim 2, wherein the RRC procedure comprises at least one of RRC Reestablishment, or RRC Resume,
wherein the obtaining the prediction further comprises determining, by the first base station, the prediction, or receiving the prediction from the UE or another network entity,
wherein obtaining the prediction comprises predicting that the connection of the UE to the first base station will be disconnected based on information on the relative movement between the UE and a cell or coverage area of the first base station,
wherein the first base station is a Non-Terrestrial Network (NTN) base station, and wherein the information on the relative movement comprises information on movement of the cell or coverage area based on movement of the NTN base station, and
wherein the information on the relative movement comprises information on movement of the UE.

4. A method of claim 1, wherein the information for performing the RRC procedure comprises a UE context for the UE, and
wherein the information for performing a Radio Resource Control (RRC) procedure is transmitted in at least one of a HANDOVER REQUEST message, and RETRIEVE UE CONTEXT RESPONSE message.

5. A method of claim 1, the method further comprising:
transmitting, to the UE, an indication that the information for performing the Radio Resource Control (RRC) procedure has been transmitted to the second base station;
transmitting, to each of one or more base stations including the second base station, a handover request message;
receiving one or more handover request acknowledgement messages in response to the handover request messages; and
transmitting, to the UE and before the connection of the UE to the first base station is disconnected, information indicating which of the base stations transmitted a handover request acknowledgement message, wherein the UE performs a cell measurement for certain base stations based on the transmitted information.

6. A method performed by a second base station, for transferring a User Equipment (UE) context from a first base station to the second base station in a wireless communication system, the method comprising:
receiving, from the first base station and before a connection of the UE to the first base station is disconnected, information for performing a Radio Resource Control (RRC) procedure for establishing a connection between the UE and the second base station;
receiving, from the UE, a message requesting the RRC procedure; and
using the received information for performing the RRC procedure.

7. A method of claim 6, the method further comprising:
deleting, by the second base station, the received information a certain time period after receiving the information; and
transmitting a message indicating that the information for performing the RRC procedure has been received by the second base station.

8. A method of claim 7, wherein the message requesting the RRC procedure is at least one of an RRC Re-establishment request message, or a RRC Resume request message.

9. A method of claim 6, the method further comprising:
transmitting a message requesting to receive information for performing the RRC procedure; and
in response to receiving the information for performing the RRC procedure, determining whether to accept the information.

10. A method of claim 6, wherein the information for performing the RRC procedure comprises a UE context for the UE.

11. A method of claim 6, the method further comprising:
in response to receiving the information for performing the RRC procedure, determining whether to accept the information;
transmitting a message indicating whether the information for performing the RRC procedure is accepted; and
transmitting a message indicating whether the information for performing the RRC procedure is rejected.

12. A method performed by a User Equipment (UE), for connecting to a base station in a wireless communication system, the method comprising:
receiving, from a first base station to which the UE is, or has been, connected, an indication that information for performing a Radio Resource Control (RRC) procedure has been transmitted to (and/or accepted by) one or more second base stations;
disconnecting from the first base station;
selecting another base station based on the received indication; and
connecting to the selected other base station.

13. A method of claim 12, wherein the other base station is selected from among the second base stations,
wherein the other base station is not selected from among the second base stations if none of the second base stations are available,
wherein the other base station is selecting according to a scheme that prioritises the second base stations.

14. A method of claim 12, the method further comprising, based on the received indication, performing a cell measurement for each of one or more cells corresponding to one or more of the second base stations.

15. A method of claim 12, wherein the cell measurements are performed before the UE disconnects from the first base station.
